(19) United States
(12) Patent Application Publication
(10) Pub. No.: US 2009/0027217 A1
(43) Pub. Date: Jan. 29, 2009

(54) Sensing apparatus for electromagnetic wave intensity

(76) Inventor: Li-Kuang Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/878,340

(22) Filed: Jul. 24, 2007

(51) Int. Cl. G08B 21/00

(52) U.S. Cl. 340/635

(57) ABSTRACT

The present invention relates to a sensing apparatus for electromagnetic (EM) wave intensity, which comprises a receiving unit, a conversion unit, and an alarm unit. The receiving unit receives an EM wave, and produces a corresponding current signal to the conversion unit. The conversion unit converts the current signal to a voltage signal, and transmits the voltage signal to the alarm unit, which produces a corresponding output signal according to the voltage signal with different intensities for notifying users that the EM wave intensity surrounding the users has reached a harmful level for human bodies. When the sensing apparatus according to the present invention senses that the EM wave intensity surrounding the users has reached a harmful level for human bodies, it will drive the alarm unit to warn the users. Thereby, human bodies can avoid exposing to harmful EM wave intensities.

### FIELD OF THE INVENTION

The present invention relates to a sensing apparatus, and particularly to a sensing apparatus for electromagnetic wave intensity.

### BACKGROUND OF THE INVENTION

With progress in technologies, people's lives become convenient increasingly and rely on technological products such as cell phones and personal digital assistants (PDAs). Meanwhile, with increasing awareness of health, people become more and more concerning about the influences of such products, for example, the electromagnetic (EM) waves, on human bodies. The longer the time people use the technological products, the severer the influences of exposing themselves in the EM wave environment on them. Thereby, people care about influences of EM waves on human bodies for avoiding pathological changes such as sterility, deformed children, and cancer.

In addition, commercial incoming-call-alarm charms for cell phones make use of the EM waves emitted by the cell phones to output an indication signal for informing the users to answer the incoming calls. However, when the users use the cell phones in an area with weak signal intensity, they can only know if a call is coming by means of the charms for cell phones, but cannot know if the received signal strength is weak when a call is coming. The cell phones will increase the EM wave intensity when they judge the base stations are distant if the received signal strength is weak. At the same time, the received signal strength displayed on the screens of the cell phones is usually ignored. In general, the user of cell phones will press the talk-key directly and attach the cells phones to the ears when an incoming call comes. However, the users are subject to health concerns when the cell phones increase their EM wave intensity if weak received signal strength is detected.

Furthermore, the Taiwan patent number I136112 entitled “Detecting Apparatus for Electromagnetic Waves” uses the detecting principle of EM waves for developing a detecting apparatus. The objective thereof is to provide an identification part to distinguish cell phone with the specified apparatus installed from the other cell phones. Besides, receiving sensitivity can also be improved; the direction of the emitting source can be detected; and the apparatus installed can be distinguished as well. Nevertheless, the EM wave intensity of the emitting source cannot be known. Moreover, a general EM wave detecting apparatus is expensive with large volume, which is bad for portability.

Accordingly, the present invention provides a novel sensing apparatus for electromagnetic waves, which can inform the users with both the existence and the intensity of the electromagnetic waves. Thereby, the users can avoid contacting high-energy electromagnetic waves.

### SUMMARY

An objective of the present invention is to provide a sensing apparatus for electromagnetic (EM) wave intensity, which provides a sensing apparatus for sensing EM waves with various intensities, and produces a corresponding output signal for notifying users the EM wave intensities in order to avoid contacting high-energy EM waves.

Another objective of the present invention is to provide a sensing apparatus with small volume, portability, and low cost.

The sensing apparatus for EM wave intensity according to the present invention comprises a receiving unit, a conversion unit, and an alarm unit. In addition, a filter is further adapted between the receiving unit and the conversion unit. The receiving unit receives an EM wave, and produces a current signal to the filter for selecting the signal frequency to be sensed by the sensing apparatus according to the present invention. The conversion unit receives the filtered current signal, converts it to a voltage signal, and transmits the voltage signal to the alarm unit, which produces a corresponding output signal according to different voltage levels, and notifies the users the EM wave intensity according to different output signals. Thereby, the users can prevent exposing themselves in an environment with harmful EM wave intensities. In addition, the sensing apparatus according to the present invention has small volume for easy carrying. Besides, the structure thereof is simple, and hence the cost is low.

### BRIEF DESCRIPTION OF THE DRAWINGS

FIG. 1 shows a block diagram according to a preferred embodiment of the present invention;

FIG. 2 shows a block diagram according to another preferred embodiment of the present invention;

FIG. 3 shows a block diagram according to another preferred embodiment of the present invention;

FIG. 4 shows a block diagram according to another preferred embodiment of the present invention;

FIG. 5 shows a block diagram according to another preferred embodiment of the present invention; and

FIG. 6 shows a block diagram according to another preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

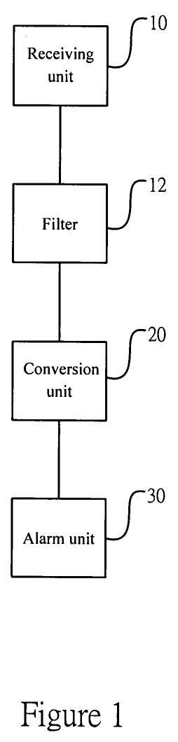

FIG. 1 shows a block diagram according to a preferred embodiment of the present invention. As shown in the figure, the present invention is a sensing apparatus for electromagnetic (EM) wave intensity, which comprises a receiving unit 10, a filter 12, a conversion unit 20, and an alarm unit 30. The receiving unit 10 connects to the filter 12, which, in turn, connects to the conversion unit 20. The alarm unit 30 connects to the conversion unit 20. The receiving unit 10 is an antenna used for receiving an EM wave in the environment of the sensing apparatus, and for producing a current signal corresponding to the EM wave to the filter 12. The filter 12 filters the current signal transmitted by the receiving unit 10 for selecting the signal frequency to be sensed by the sensing apparatus according to the present invention. The conversion unit 20 is a current-to-voltage conversion circuit used for converting the filtered current signal to a voltage signal, whose intensity corresponds to the intensity of the EM wave. The alarm unit 30 outputs a corresponding output signal according to the intensity of the voltage signal, and is a display unit or a sound-effect output unit. If the alarm unit 30 is a display unit, then it will display corresponding different luminance of light or color according to the intensity of the voltage signal. On the other hand, if the alarm unit 30 is a sound-effect output unit, then it will output a first sound effect corresponding to the frequency or a second sound effect corresponding to the volume according to the intensity of the voltage signal.

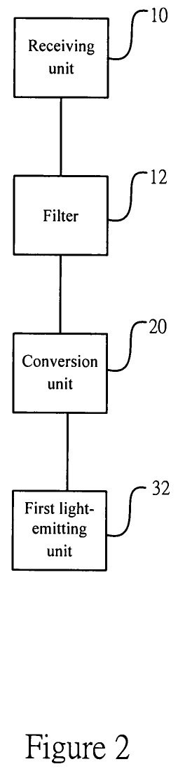

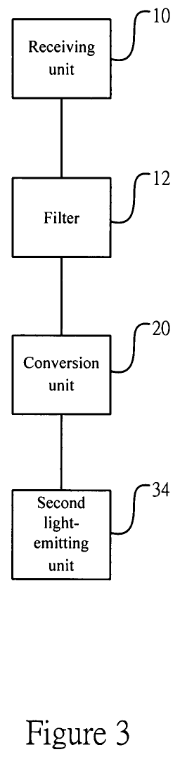

As shown in FIG. 2, the alarm unit is a first light-emitting unit 32, which displays different luminance of light according to the intensity of the voltage signal. The EM wave received by the receiving unit 10 is differentiated according to a first threshold and a second threshold. When the receiving unit 10 receives the EM wave and the intensity of the EM wave does not reach the first threshold, the first light-emitting unit 32 will be driven to emit light with first luminance. When the receiving unit 10 receives the EM wave and the intensity of the EM wave locates between the first and the second thresholds, the first light-emitting unit 32 will be driven to emit light with second luminance. When the receiving unit 10 receives the EM wave and the intensity of the EM wave reaches or exceeds the second threshold, the first light-emitting unit 32 will be driven to emit light with third luminance. As shown in FIG. 3, the alarm unit is a second light-emitting unit 34, which displays different colors according to the intensity of the voltage signal. The EM wave received by the receiving unit 10 is differentiated according to a first threshold and a second threshold. When the receiving unit 10 receives the EM wave and the intensity of the EM wave does not reach the first threshold, the second light-emitting unit 34 will be driven to emit light with a first color. When the receiving unit 10 receives the EM wave and the intensity of the EM wave locates between the first and the second thresholds, the second light-emitting unit 34 will be driven to emit light with a second color. When the receiving unit 10 receives the EM wave and the intensity of the EM wave reaches or exceeds the second threshold, the second light-emitting unit 34 will be driven to emit light with a third color, which represents that the EM wave received by the receiving unit 10 is energetic and is harmful to human bodies.

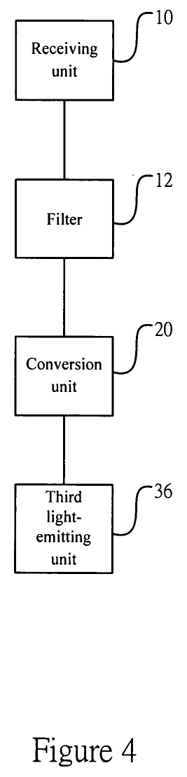

As shown in FIG. 4, the alarm unit is a third light-emitting unit 36 with a plurality of light-emitting diodes (LEDs), which displays different number of light sources according to the intensity of the voltage signal. The EM wave received by the receiving unit 10 is differentiated according to a first threshold and a second threshold. When the receiving unit 10 receives the EM wave and the intensity of the EM wave does not reach the first threshold, one LED of the third light-emitting unit 36 will be driven to emit light. When the receiving unit 10 receives the EM wave and the intensity of the EM wave locates between the first and the second thresholds, three LEDs of the third light-emitting unit 36 will be driven to emit light. When the receiving unit 10 receives the EM wave and the intensity of the EM wave reaches or exceeds the second threshold, all LEDs of the third light-emitting unit 36 will be driven to emit light, which represents that the EM wave received by the receiving unit 10 is energetic and is harmful to human bodies.

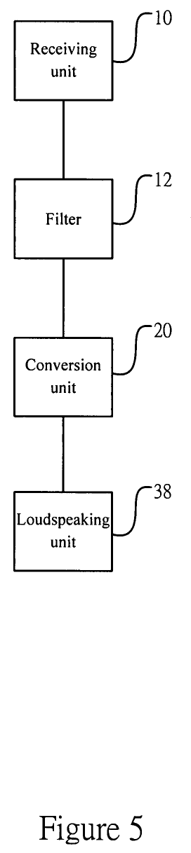

As shown in FIG. 5, the alarm unit is a loudspeaking unit 38, which outputs a first sound effect with different audio frequencies according to the intensity of the voltage signal. The EM wave received by the receiving unit 10 is differentiated according to a first threshold and a second threshold. When the receiving unit 10 receives the EM wave and the intensity of the EM wave does not reach the first threshold, the loudspeaking unit 38 will be driven to produce the first sound effect with a first frequency. When the receiving unit 10 receives the EM wave and the intensity of the EM wave locates between the first and the second thresholds, the loudspeaking unit 38 will be driven to produce the first sound effect with a second frequency. When the receiving unit 10 receives the EM wave and the intensity of the EM wave reaches or exceeds the second threshold, the loudspeaking unit 38 will be driven to produce the first sound effect with a third frequency, which represents that the EM wave received by the receiving unit 10 is energetic and is harmful to human bodies. For example, the loudspeaking unit 38 is a loudspeaker, which adjusts the audio frequencies according to the EM wave intensity received by the receiving unit 10. When the EM wave intensity does not reach the first threshold, the loudspeaking unit 38 will produce sound with the first frequency. When the EM wave intensity locates between the first and the second thresholds, the loudspeaking unit 38 will produce sound with the second frequency. When the EM wave intensity reaches or exceeds the second threshold, the loudspeaking unit 38 will produce sound with the third frequency.

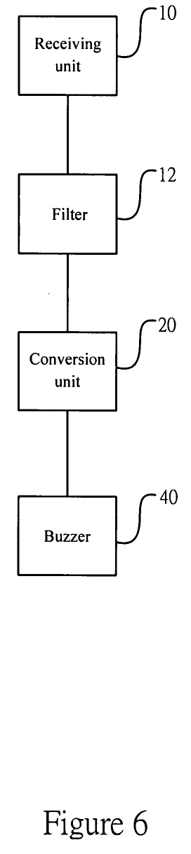

As shown in FIG. 6, the alarm unit is a buzzer 40, which outputs a second sound effect with different volume according to the intensity of the voltage signal. The EM wave received by the receiving unit 10 is differentiated according to a first threshold and a second threshold. When the receiving unit 10 receives the EM wave and the intensity of the EM wave does not reach the first threshold, the buzzer 40 will be driven to produce the second sound effect with first volume. When the receiving unit 10 receives the EM wave and the intensity of the EM wave locates between the first and the second thresholds, the buzzer 40 will be driven to produce the second sound effect with second volume. When the receiving unit 10 receives the EM wave and the intensity of the EM wave reaches or exceeds the second threshold, the buzzer 40 will be driven to produce the second sound effect with third volume, which represents that the EM wave received by the receiving unit 10 is energetic and is harmful to human bodies. For example, the buzzer 40 adjusts the audio volume according to the EM wave intensity received by the receiving unit 10. When the EM wave intensity does not reach the first threshold, the buzzer 40 will produce buzzing sound with the first volume. When the EM wave intensity locates between the first and the second thresholds, the buzzer 40 will produce buzzing sound with the second volume. When the EM wave intensity reaches or exceeds the second threshold, the buzzer 40 will produce buzzing sound with the third volume.

Furthermore, it is known from the above description that the structure of the sensing apparatus according to the present invention is simple, and hence the manufacturing cost is low. Besides, the volume of the circuit of the sensing apparatus according to the present invention is small. Thereby, it is easy for carrying. In addition, an integrated circuit (IC) can be further adapted.

To sum up, the present invention relates to a sensing apparatus, which comprises a receiving unit, a conversion unit, and an alarm unit. The receiving unit connects to the conversion unit via a filter. The alarm unit receives the output signal of the conversion unit. The receiving unit receives an electromagnetic (EM) wave and produces a corresponding current signal to the filter. The filter filters the current signal for selecting the signal frequency to be sensed. The conversion unit converts the filtered current signal to a voltage signal, whose intensity corresponds to the EM wave intensity received by the receiving unit. Thereby, the alarm unit outputs a corresponding output signal according to the intensity of the voltage signal for the users to know the EM wave intensity in which they are exposed. Consequently, the sensing apparatus according to the present invention notifies the users if the EM wave intensity reaches the harmful strength for human bodies via the output signal of the alarm unit. If the EM wave intensity reaches or exceeds the level of doing harm to human bodies, the users are notified that the EM wave received by the receiving unit has harmfully high energy.

Accordingly, the present invention conforms to the legal requirements owing to its novelty, non-obviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A sensing apparatus for electromagnetic (EM) wave intensity, comprising:
a receiving unit, receiving an EM wave, and producing a current signal corresponding to the EM wave;
a conversion unit, converting the current signal to a voltage signal with intensity corresponding to the EM wave intensity; and
an alarm unit, producing an output signal corresponding to the intensity of the voltage signal.

2. The sensing apparatus of claim 1, wherein a filter is adapted between the receiving unit and the conversion unit for filtering the current signal.

3. The sensing apparatus of claim 1, wherein the alarm unit is a display unit.

4. The sensing apparatus of claim 3, wherein the display unit displays corresponding luminance of light according to the intensity of the voltage signal.

5. The sensing apparatus of claim 3, wherein the display unit displays a corresponding color light according to the intensity of the voltage signal.

6. The sensing apparatus of claim 3, wherein the display unit displays a corresponding number of lights according to the intensity of the voltage signal.

7. The sensing apparatus of claim 3, wherein the display unit is one or more light-emitting diodes (LEDs).

8. The sensing apparatus of claim 1, wherein the alarm unit is a sound-effect output unit.

9. The sensing apparatus of claim 8, wherein the sound-effect output unit outputs a first sound effect corresponding to audio frequencies according to the intensity of the voltage signal.

10. The sensing apparatus of claim 9, wherein the first sound effect is a ring.

11. The sensing apparatus of claim 8, wherein the sound-effect output unit outputs a second sound effect corresponding to audio volume according to the intensity of the voltage signal.

12. The sensing apparatus of claim 11, wherein the second sound effect is a buzzing sound.
